(19) United States
(12) Patent Application Publication
(10) Pub. No.: US 2010/0126064 A1
(43) Pub. Date: May 27, 2010

(54) PLANT FASTENER AND METHOD OF FASTENING A PLANT TO A TRELLIS

(76) Inventor: Nils Cunningham, Oakland, CA (US)

Correspondence Address: STEVEN VOSEN, 1563 SOLANO AVENUE #206, BERKELEY, CA, 94707, US

(21) Appl. No.: 12/624,297

(22) Filed: Nov. 23, 2009

Related U.S. Application Data
(60) Provisional application No. 61/117,691, filed on Nov. 25, 2008.

(51) Int. Cl. A01G 17/08

(52) U.S. Cl. 47/44; 47/58.1 R

(57) ABSTRACT

A fastener and method of securing a plant to a wire is described. The fastener may be used, for example, to secure a grapevine to a foliage wire. In one embodiment, a flexible fastener is provided that can secure the plant. The fastener includes two convex portions for attaching to the wire, and can deform to restrain the plant against the wire. In one embodiment, the fastener is deformable to allow the two convex portions to overlap and accept the wire, thus restraining a plant. In another embodiment, a biodegradable fastener is provided that can easily secure a plant to a wire, and which can be left in the field to decompose.

### CROSS-REFERENCE TO RELATED APPLICATIONS

This application claims the benefit of U.S. Provisional Application No. 61/117,691, filed Nov. 25, 2008, which is incorporated herein by reference.

### BACKGROUND OF THE INVENTION

1. Field of the Invention

The present invention generally relates to devices used for supporting plants, and more particularly to a fastener to support foliage on a wire and a method of fastening foliage to a wire.

2. Discussion of the Background

The conventional method of raising grapes or raisins in vineyards is to grow the grape vines in separate, parallel rows utilizing a trellis system of foliage wires that are suspended above the ground. The vines are secured to the foliage wires with ties, which may be formed from string, wire, or plastic. Typically the tie material is supplied from spools.

While the use of such prior art ties is effective, the use of these ties has several problems. First, using the ties tends to be time consuming work. If the tie material is provided on spools, the ties must be cut to length as needed, and are tied using both hands. Further, the ties need to be removed using cutting tools at the end of the growing season and disposed of.

Thus there is a need in the art for an apparatus that permits for the easy and quick fastening of plants in the field. Such an apparatus should require less work and tools than current fastening systems, and should preferable produce less waste or residue.

### BRIEF SUMMARY OF THE INVENTION

The present invention overcomes the disadvantages of prior art by providing individual fasteners that can be used to secure a plant to a wire.

In one embodiment, a flexible fastener is provided that can secure a plant to a foliage wire. The fastener is configured to receive a foliage wire and a vine, and may easily be deformed to attach the vine to the wire. In one embodiment, the fastener has two arms that are joined at a proximal, that are generally parallel, and which each include a portion near a distal end to attach to the wire.

In another embodiment, a fastener is provided to that is attachable to a wire having a diameter. The fastener is generally planar and flexible, said includes a fastener end, a first portion attached to the fastener end. The first portion is attached to the fastener end and includes a first convex portion. The second portion is attached to the fastener end and includes a second convex portion. The first portion and said second portion form an open aperture through said fastener, with said first convex portion and said second convex portion opening into said aperture.

In yet another embodiment, a fastener attachable to a wire having a diameter is provided. The fastener includes a body, where the body has a proximal portion, where the body is generally planar, and where the body includes a first portion and a second portion. The first portion is joined to the proximal portion and includes a first convex portion, and the second portion is joined to the proximal portion and includes a second convex portion. The body is sufficiently flexible to overlap the first convex portion and the second convex portion to form a closed configuration, where the closed configuration includes a closed aperture bounded by the first portion and the second portion.

In another embodiment, fastener includes two arms that are each flexible and which can be closed about a wire to attach the vine to a wire. The fastener deforms between the overlapped notches and the third portion to force the plant against the wire.

In another embodiment, a method of securing a vine to a wire using a fastener is provided. The fastener is planar and includes a central portion, a first portion extending from the central portion and including a first wire fastener, and a second portion extending from the central portion and including a second wire fastener. The method includes placing a fastener over the wire, placing the first portion over the vine, attaching the first wire fastener to the wire, placing the second portion over the vine, and attaching the second wire fastener to the wire.

In another embodiment, a biodegradable fastener is provided that can easily secure a plant to a wire, and which can be left in the field to decompose.

These features, together with the various ancillary provisions and features which will become apparent to those skilled in the art from the following detailed description, are attained by the plant fastener of the present invention, preferred embodiments thereof being shown with reference to the accompanying drawings, by way of example only, wherein:

### BRIEF DESCRIPTION OF THE SEVERAL VIEWS OF THE DRAWING

FIG. 1A is a top view of first embodiment of a fastener in an open configuration;

FIG. 1B is side view of the fastener of FIG. 1A;

FIG. 2A is a top view of the fastener of FIG. 1A in a closed configuration;

FIG. 2B is side view of the fastener of FIG. 1A; and

FIGS. 3A, 3B, 3C and 3D illustrate one use of the fastener for the securing of a vine to a foliage wire, where FIG. 3A is a front view of the fastener partially put in place, FIG. 3B is a front view of the next step at securing fastener, and FIGS. 3C and 3D are front and rear views, respectively, of the secured fastener.

Reference symbols are used in the Figures to indicate certain components, aspects or features shown therein, with reference symbols common to more than one Figure indicating like components, aspects or features shown therein.

### DETAILED DESCRIPTION OF THE INVENTION

Embodiments are presented herein for fasteners which may be used, for example and without limitation, to facilitate the positioning of plants. As one example of the use of such fasteners, grape vines are typically grown by attaching the vine to a wire of a grape trellis.

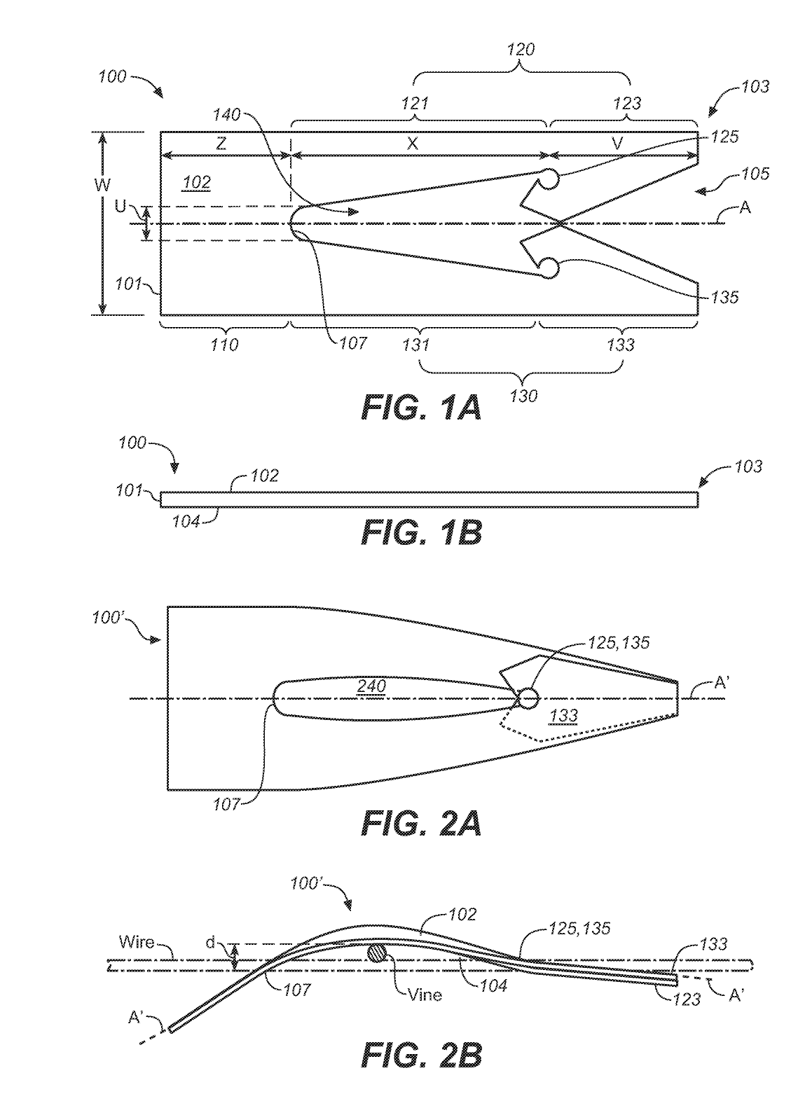

FIG. 1A is a top view and FIG. 1B is a side view of first embodiment of a fastener 100 as shown in an open, relaxed configuration. Fastener 100 is preferably formed from a flexible sheet or planar piece of material having an opposing top surface 102 and bottom surface 104. In general, fastener 100 has a proximal, or back end 101 and distal, or front end 103 that includes an opening 105 that provides access to an open aperture, or interior area 140. In the specific embodiment illustrated in FIGS. 1A and 1B, fastener 100 includes a fastener end 110 that includes back end 101, and a first arm 120 and a second arm 130 that include front end 103 and opening 105. As described subsequently, a plant and a foliage wire may be inserted into opening 105, and restrained within interior area 140.

As is further shown in FIG. 1A, arms 120, 130 each include corresponding proximal portions 121, 131 that meet at a proximal end 107 of interior area 140, and which extend a length X from proximal end 107 to concave portions 125, 135, and also include distal portions 123, 133 that extend a length V from the portions to front end 103. Concave portions 125, 135 each open into interior area 140. Arms 120, 130 meet at fastener end 110 and are otherwise separate from each other to form opening 105.

In certain embodiments, arms 120 and 130 may be are generally similar in shape and may be mirror images of one another. Thus, for example and without limitation, FIG. 1A illustrates an axis A that extends from back end 101 to front end 103.

In one embodiment, fastener end 110 may be sized to be conveniently gripped between the thumb and the index finger. Thus, for example and without limitation, one or both of W and Z may each be between approximately 20 mm and approximately 50 mm. Thus for example, and without limitation, either W or Z may be approximately 20 mm, approximately 25 mm, approximately 30 mm, approximately 35 mm, approximately 40 mm, approximately 45 mm, or approximately 50 mm. In addition, while fastener end 110 is shown as being approximately square, the fastener end may be rectangular, oval, or any other shape that can connect arms 120 and 130.

Proximal portions 121, 131 may be sized and positioned such that area 140 has a length X and width U sized to bend around a plant of interest. For grapevines, X may be between 35 and 75 mm. In general, length X may be, for example and without limitation, between approximately 25 mm and approximately 100 mm, and may be, approximately 25 mm, approximately 35 mm, approximately 50 mm, approximately 75 mm, or approximately 100 mm. Width U may have a minimum size that may be between 0 mm and 20 mm. and may be, for example and without limitation, approximately 0 mm, approximately 2 mm, approximately 4 mm, approximately 6 mm, approximately 8 mm, approximately 10 mm, approximately 12 mm, approximately 14 mm, approximately 16 mm, approximately 18 mm, or approximately 20 mm. Further, while area 140 is shown as having a wedge shape and a semicircular end, the area may be rectangular, square, have sharp edges, or other shapes that permit portions 125 and 135 to overlap.

Distal portions 123, 133 may be sized to provide overlap when portions 125 and 135 overlap, and have a length V that may be between approximately 0 mm and approximately 40 mm.

Convex portions 125 and 135 are sized to restrain a wire. Foliage wires of 13 gauge are common, and thus convex portions 125 and 135 may have a diameter of approximately 3 mm. Other size convex portions 125 and 135 may be chosen for use with different sized wires.

As shown in FIG. 1B, fastener 100 has a thickness between top surface 102 and bottom surface 104. The thickness may be from 0.25 mm to 1.50 mm. Thus in various embodiments, thickness is 0.25 mm, 0.50 mm, 0.75 mm, 1.00 mm, 1.25 mm, or 1.50 mm.

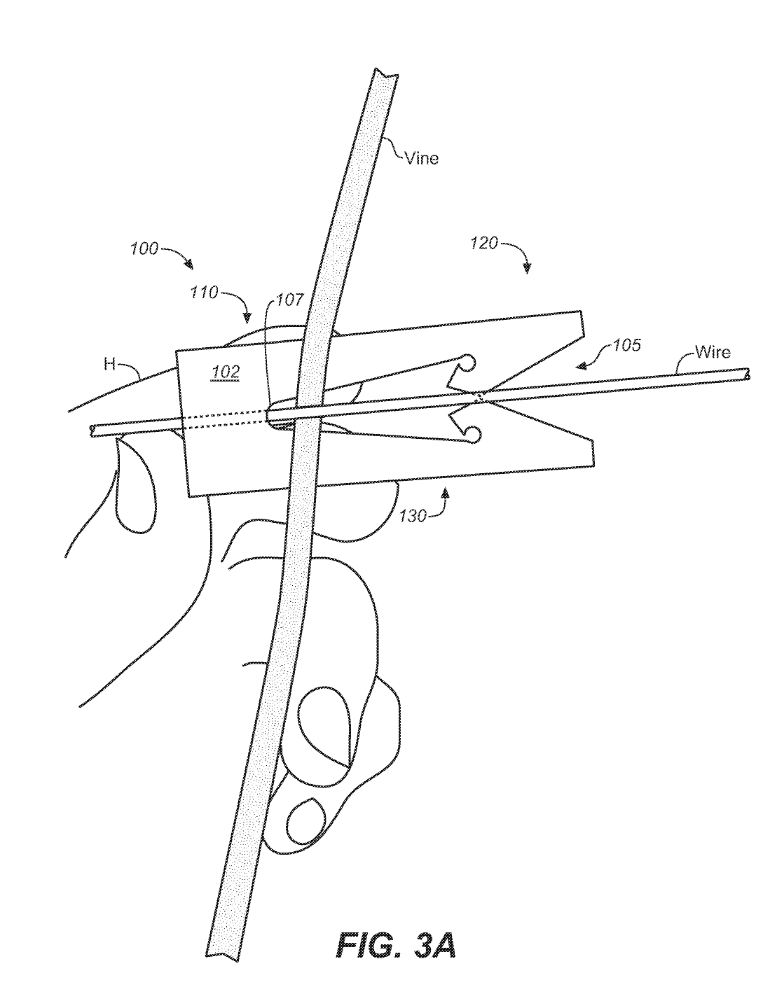

FIG. 2A is a top view and FIG. 2B is a side view of fastener 100 in a closed configuration 100′. As shown in FIG. 2B, fastener 100′ aligns portions 125, 135 by overlapping with distal ends 123, 133. As shown in FIG. 2B, the alignment of portions 125, 135 warps the shape of fastener 100′, resulting axis A being bent into a curve A′ which is out of the plane of fastener 100. Fastener 100′ thus configured forms an enclosed aperture or area 240 that is bounded by fastener end 110 and proximal ends 121 and 131, and which extends from proximal end 107 to aligned portions 125, 135.

One example of the use of fastener 100′ is illustrated in FIG. 2B. Fastener 100′ may restrain a vine that is placed approximately perpendicular to a foliage wire, by having the wire pass within enclosed area 240 near proximal end 107 and through aligned portions 125, 135, and having the vine secured between fastener 100′ and the wire. In certain embodiments, the shape of portions 125 and 135 act to fasten the wire to arms 120 and 130, respectively. With wire against proximal end 107 and through aligned portions 125, 135, fastener 100′ is bent out-of-plane by a distance d, which may accommodate the vine.

Fastener 100 may be manufactured from a variety of materials. In one embodiment, fastener 100 is biodegradable. In another embodiment, fastener 100 is formed from a paper or hemp product, such as card stock or cardboard. In another embodiment, fastener 100 is formed from a paper or hemp product having a waxed finish. In one embodiment, fastener 100 is formed from a plastic. In yet another embodiment, fastener 100 is formed from a biodegradable plastic.

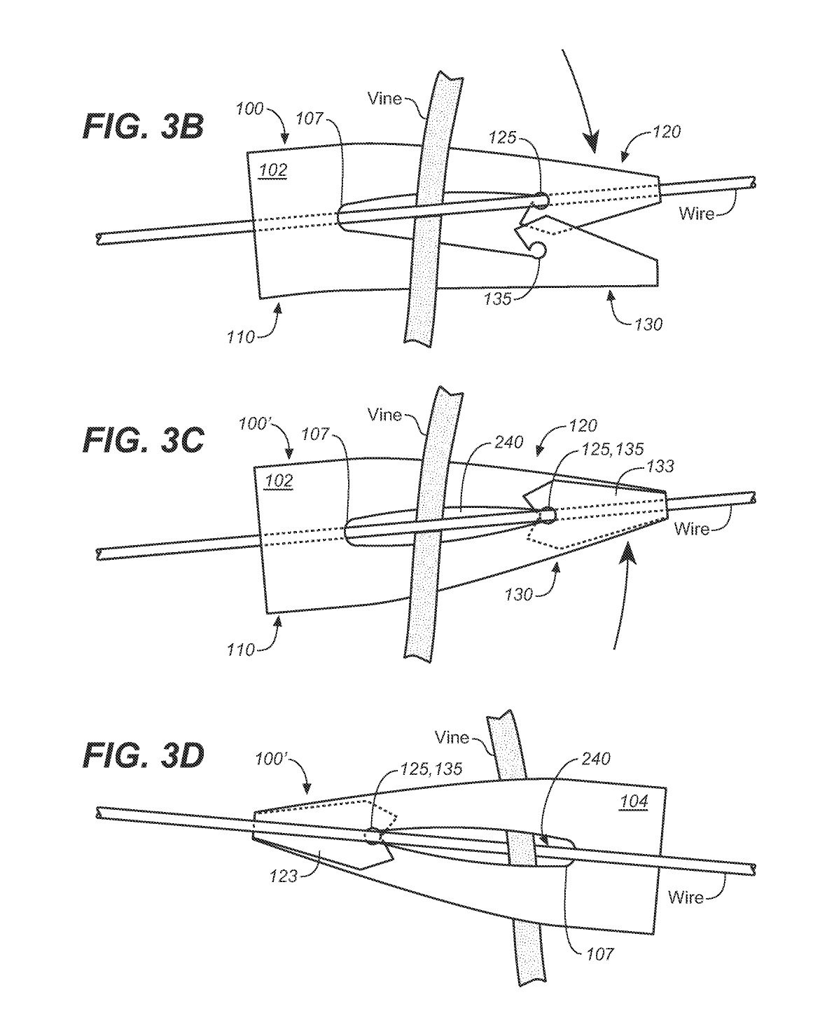

As a further example of the user of fastener 100, FIGS. 3A, 3B, 3C and 3D illustrates one use of the fastener for the securing of a vine to a foliage wire.

FIG. 3A illustrates a front view of fastener 100 partially put in place. Prior to the illustration of FIG. 3A, the hand H of the user has forced the wire through opening 105, and positioned the wire against proximal end 107. In the view of FIG. 3A, fastener end 110 is in front of the wire, and arms 120 and 130 are behind the vine and the wire.

FIG. 3B illustrates a front view of the next step at securing fastener 100. Arm 120 is bent forward in front of the wire, and the wire is placed within portion 125, securing the arm to the wire.

FIGS. 3C and 3D illustrate the final step in securing fastener 100, where FIG. 3C is a front view and FIG. 3D is a rear view. In FIGS. 3C and 3D, arm 130 is bent in front of the wire and arm 120, and the wire is placed within portion 135. The fastener is thus generally configured the same as fastener 100′ of FIG. 2A and 2B, which aligned portions 125 and 135.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

I Claim:

1. A fastener attachable to a wire having a diameter, where the fastener is generally planar and flexible, said fastener comprising:
a fastener end;
a first portion attached to said fastener end and including a first convex portion; and
a second portion attached to said fastener end and including a second convex portion,
where said first portion and said second portion form an open aperture through said fastener, and where said first convex portion and said second convex portion open into said aperture.

2. The fastener of claim 1, where said fastener is sufficiently flexible to overlap said first convex portion and said second convex portion to form a closed aperture bounded by said first portion and said second portion, such that a wire placed through said first and second convex portions retain the fastener in a closed configuration.

3. The fastener of claim 2, where said closed aperture is sized to accept the wire and hold a vine adjacent to the wire.

4. The fastener of claim 2, where said closed aperture has a length of from approximately 20 mm to approximately 50 mm.

5. The fastener of claim 1, where said fastener end has a size of approximately 30 mm by 30 mm.

6. The fastener of claim 1, where said first portion is a mirror image of said second portion.

7. The fastener of claim 1, where said first convex portion and said second convex portion are each sized to accept a wire having a diameter of approximately 3 mm.

8. The fastener of claim 1, where said first portion further includes a first distal portion distal from said first convex portion, where said second portion includes a second distal portion distal from said second convex portion, and where, when said first and second convex portions overlap, said first distal portion overlaps said second distal portion.

9. The fastener of claim 1, where said fastener is a biodegradable plastic.

10. The fastener of claim 1, where said fastener is a paper product.

11. A fastener attachable to a wire having a diameter, said fastener comprising:
a body, where said body has a proximal portion, where said body is generally planar, and where said body includes
a first portion joined to said proximal portion and including a first convex portion, and
a second portion joined to said proximal portion and including a second convex portion,
where said body is sufficiently flexible to overlap said first convex portion and said second convex portion to form a closed configuration, where said closed configuration include a closed aperture bounded by said first portion and said second portion.

12. The fastener of claim 11, where said first convex portion and said second convex portion of said closed configuration is sized to accept the wire, where the accepted wire retains the fastener in a closed configuration, and where said closed aperture is sized to hold a vine adjacent to the wire.

13. The fastener of claim 11, where said closed aperture has a length of from 20 mm to 50 mm.

14. The fastener of claim 11, where said proximal portion has a size of approximately 30 mm by 30 mm.

15. The fastener of claim 11, where said first portion is a mirror image of said second portion.

16. The fastener of claim 11, where said first convex portion and said second convex portion are each sized to accept a wire having a diameter of approximately 3 mm, and where the accepted wire restrains said fastener in the closed configuration.

17. The fastener of claim 11, where said first portion further includes a first distal portion distal from said first convex portion, where said second portion includes a second distal portion distal from said second convex portion, and where, when said first and second convex portions overlap, said first distal portion overlaps said second distal portion.

18. The fastener of claim 11, where said body is a biodegradable plastic.

19. The fastener of claim 11, where said body is a paper product.

20. A method of securing a vine to a wire using a fastener, said method comprising:
placing a fastener over the wire, where the fastener is planar and includes a central portion, a first portion extending from the central portion and including a first wire fastener, and a second portion extending from the central portion and including a second wire fastener,
placing the first portion over the vine;
attaching the first wire fastener to the wire;
placing the second portion over the vine; and
attaching the second wire fastener to the wire.

21. The method of claim 20, where the first wire fastener includes a convex portion and the second wire fastener includes a second convex portion, where said attaching the first wire fastener to the wire includes placing the wire within the first convex portion, and where attaching the first wire fastener to the wire includes placing the wire within the second convex portion.

22. The method of claim 20, where said fastener is a biodegradable plastic.

23. The method of claim 20, where said fastener is a paper product.
